(19) United States
(12) Patent Application Publication
(10) Pub. No.: US 2022/0001628 A1
(43) Pub. Date: Jan. 6, 2022

(54) METHOD FOR PRODUCING A SELF-REINFORCED THERMOPLASTIC COMPOSITE MATERIAL

(71) Applicant: FOND OF GMBH, Koeln (DE)

(72) Inventor: Michel JANSEN, Ruurlo (NL)

(73) Assignee: FOND OF GMBH, Koeln (DE)

(21) Appl. No.: 17/479,762

(22) Filed: Sep. 20, 2021

Related U.S. Application Data
(63) Continuation of application No. PCT/DE2020/100217, filed on Mar. 18, 2020.

(30) Foreign Application Priority Data
Mar. 18, 2019 (DE) 10 2019 106 772.3

(51) Int. Cl. B29C 70/22; B29C 70/34; A45C 5/02; A45C 13/10; D03D 15/46; D03D 15/283

(52) U.S. Cl. CPC B29C 70/22; B29C 70/345; A45C 5/02; B29K 2067/003; D03D 15/46; D03D 15/283; A45C 13/103

(57) ABSTRACT

The invention relates to a method for producing a self-reinforced thermoplastic composite material including: providing strips of a thermoplastic and weaving the plastic strips into a base fabric. The plastic strips for this are produced by at least the following steps: producing pre-stretched fibres from a partially crystalline polyester homopolymer with a melting point by extrusion on at least one spinning nozzle and subsequent stretching and joining a plurality of pre-stretched endless fibres lying next to and/or above one another to a matrix of an amorphous polyester homopolymer at a processing temperature T2<T1, wherein the temperature difference between T1 and T2 is at least ΔT=30° C.

This nonprovisional application is a continuation of International Application No. PCT/DE2020/100217, which was filed on Mar. 18, 2020, and which claims priority to German Patent Application No. 10 2019 106 772.3, which was filed in Germany on Mar. 18, 2019, and which are both herein incorporated by reference.

### BACKGROUND OF THE INVENTION

### Field of the Invention

The present invention relates to a method of producing a self-reinforced thermoplastic composite material.

### Description of the Background Art

From WO 2005123369 A1, which corresponds to US 2007/0296117, pieces of luggage are known in which structural elements such as, in particular, the half-shells are made of a polyolefinic composite material which has a high impact resistance and a low specific weight. The composite material includes a fabric of pre-stretched plastic strips formed from blanks of a film of polypropylene, polyethylene, or a copolymer thereof. These cases have very good usage properties and are very durable. However, the production is very complex and requires high investments in the production equipment. A fundamental problem in manufacturing is that the plastic strips have to be pre-stretched to achieve higher mechanical strength. The production of the half-shells or other structural elements is then carried out by hot forming of fabric blanks in a heated mold. During hot forming, however, the pre-stretched plastic strips partially shrink. Clamping frames are required to counteract this, so appropriate investment in equipment and precise temperature control are necessary. Although the cases obtained in this way are very impact resistant, even at low temperatures, they also have a high elastic deformability. A higher form stiffness is desirable especially for handling the still open case.

Another disadvantage is that the polyolefinic plastic from which the half-shells and other structural elements are made, can in principle be recycled by type, but that the material quality decreases with each recycling process until finally only incineration is possible.

U.S. Pat. No. 5,380,477 A describes a fiber-reinforced laminate formed from a matrix of polyamide (“nylon”) and so-called “bico” fibers, which combine two plastics. For example, a core is made of polyester, while a sheath is also made of polyamide. The fibers are used to form so-called non-wovens, i.e., non-woven fabrics. Several fabric blanks are then joined together in a mold under the action of pressure and temperature. In the process, the sheath of the reinforcing fibers melts and bonds with the similar synthetic material of the matrix fibers. The reinforcing fibers formed from a different plastic are thus embedded in the matrix. However, the laminates formed in this way contain two plastics, so that recycling by type is not possible.

DE 10 2016 205 556 A1 is described how a mixture of amorphous and semi-crystalline and amorphous polyester fibers is to be processed. In the end, a structural part with a partially crystalline matrix is to be obtained thereby. That a nonwoven fabric with amorphous fibers is brought to partial crystallization. However, such an in-situ crystallization does not provide a high mechanical strength.

### SUMMARY OF THE INVENTION

It is therefore an object of the present invention to provide a self-reinforced and highly resilient thermoplastic composite material which is sustainably recyclable and which, moreover, can be manufactured and further processed more cost-effectively by dispensing with further processing in the clamping frame.

The invention thus provides a composite material in the form of a ribbon fabric as a base fabric, from which structural elements can later be produced by hot forming in a press mold. Essential to the invention is, on the one hand, the choice of material and the structure of the plastic tapes used for this purpose.

Because the plastic tapes according to the invention are chemically made of the same thermoplastic material, which however is present in two different embodiments, namely crystallinities, a large distance between the temperature of the matrix material and the fiber material of at least 30° C., in particular even of 50° C., is created. This large distance between the temperatures allows further processing of the base fabric on much simpler and thus less expensive devices. A temperature control accurate to the degree is not necessary, and the use of clamping frames in the manufacture of structural parts can be dispensed with.

According to the invention, a high mechanical load-bearing capacity is achieved by using pre-stretched polyester fibers which are produced in a continuous form and embedded in the matrix. Thus, the fibers are stretched and integrated into the matrix in a unidirectionally oriented manner. The pre-stretched reinforcing polyester fibers embedded in the matrix do not shrink during subsequent hot forming of the fabric blank, or do not shrink to an extent that affects the quality of the product. This means that shrinkage- and distortion-free elements can be obtained without high manufacturing costs. This is mainly due to the large temperature gap between the individual components of the composite material, so that the fiber component remains unaffected in any case during subsequent structuring by hot forming.

It is essential to the invention with regard to recycling that both the matrix and the fibers contained therein as multifilaments are formed of or consist of polyester. The special feature according to the invention includes using partially crystalline polyester for the fibers and amorphous polyester for the matrix. Since in each case homopolymers or PET copolymers are preferably used, but no other polymers, there are no interfering materials for a later recycling process.

The separation into semi-crystalline polyester for the fibers and amorphous polyester for the matrix leads to the high temperature difference ΔT between the respective processing temperatures of the two components fibers and matrix, whereby the temperature at which the fibers are affected to such an extent that they lose their strength or even dimensional stability is significantly higher than the processing temperature for the matrix.

Due to this temperature difference, the fibers remain unaffected when they are embedded in the matrix. The fibers are therefore not heated too much when the matrix is applied. During subsequent hot forming of the base fabric produced from the plastic tapes, the matrix is heated only to such an extent that permanent plastic forming is possible and/or, if necessary, several fabric layers can be joined together, but that the mechanical properties of the fibers contained in the matrix are not impaired in the process.

A very advantageous side effect of said material selection is that semi-crystalline polyester is stretchable. As according to the invention pre-stretched fibers of semi-crystalline polyester can be subsequently embedded in a matrix, a high strength—when loaded in the direction of extension of the continuous fibers—of about 400 MPa can be achieved.

The selection of polyester as the starting material achieves an enormous sustainability of the product, because with polyester as a thermoplastic polycondensate, the product properties can be specifically adjusted during the recycling process, and thus the recycled polyester, so-called R-PET, has at least the same product properties as virgin material. The reprocessing process can be repeated as often as required, so that residual pieces of the composite material, but also parts manufactured from it, can be reprocessed according to type at the end of their useful life. If, for example, suitcases are manufactured from the composite material, then suitcases returned by customers can be used for the manufacture of new suitcases without any loss of quality. Furthermore, the polyester waste that accumulates everywhere in various forms can be used.

An advantage of the choice of material according to the invention is that all other elements required for a piece of luggage can also be manufactured from polyester. Textile elements can be welded or glued to the structural elements. Textile elements can be sewn to each other, and the seam can also be made with a thread of polyester. The half-shells may be connected by a zipper made of polyester. Injection molded parts can also be made of polyester, so that the suitcase produced in this way can be recycled according to type.

Further advantages of the material selection according to the invention are that the mechanical properties can be easily adjusted via the degree of stretching of the fibers, that the plastic tapes can be easily colored and that there is a strong bond between the fibers and the matrix which does not come loose even under load.

The process described below is used to manufacture the case. In addition to the selection of materials for manufacturing the plastic straps, the temperature control of the overall process is particularly important.

First, the plastic ribbons are produced. To this end, pre-stretched fibers are first made from a semi-crystalline polyester homopolymer having a melting temperature TS1 by extrusion with at least one spinneret and subsequent stretching. The semi-crystalline polyester homopolymer has a relative degree of crystallization of more than 75%, based on the absolute crystallinity of the polymer, and a melting temperature of about 260° C.±10°. Preferably, the fibers are spooled and then further processed from spools to compensate for the different throughput rates during fiber spinning and matrix production.

The fibers are preferably processed as multifilaments, i.e., as a bundle of a plurality of individual fibers, but without twisting, etc.

The uncoiled multifilaments are spread so that the fiber layer becomes wider and less high. This results in the adaptation to the desired thin rectangular profile of the cross-section of the plastic belt.

The matrix is formed either by online extrusion or by the so-called film stacking process. Both enable the fibers to be embedded in the matrix in a tightened and directed manner, so that substantially higher strengths can be achieved in linear extension of the plastic tapes produced according to the invention than when using non-woven webs according to the prior art mentioned at the beginning.

In on-line extrusion, the prepared bundle of fibers is passed through a wetting die of an extruder, i.e., a die which allows the fibers to pass through and, at the same time, an application of liquid polyester melt to form a matrix which surrounds the fibers. The matrix is formed from a predominantly amorphous polyester homopolymer having a processing temperature T2 of about 210° C. This temperature is sufficient to press a flowable melt into the wetting tool and produce the plastic tape with embedded fibers.

The fibers remain unaffected because the temperature difference ΔT between the processing temperature during extrusion and the melting point of the fibers is 50° C. The temperature difference should be at least 30° C., preferably 50° C.

The strand exiting the wetting tool can then be cooled and calibrated in a known manner, for example by passing it through a pair of calender rollers.

Even more advantageously, the film stacking process is used to produce the plastic tapes of the invention. In this process, two films are rolled together in a hot state, sandwiching the reinforcing fiber strands between them. According to the invention, two films of amorphous polyester are used for this purpose. The pre-stretched reinforcing fibers of semi-crystalline polyester are introduced between the films and passed, for example, through a calender roll nip. In this process, the reinforcing fibers introduced in a continuous strand can be guided well in a tightened and linearly aligned state. The bonding of the two films then takes place under the influence of pressure and temperature in the roll nip. Again, a maximum processing temperature T2 is set as mentioned above. Since the pressure has an additional influence on the joining of the films, the processing temperature can be even lower than in the case of online extrusion, so that the preferably maintained temperature difference of 50° C. between the processing temperature of the matrix and the temperature above which the fibers are negatively influenced can be achieved in any case.

The draw-off can be carried out in both manufacturing processes via rubberized rollers. For reasons of economy, a wide strip is extruded first, which is then divided into several individual plastic strips with the desired width of 2 mm to 25 mm.

The plastic ribbons are then woven together in the usual way in warp and weft, for example in plain weave or twill weave. The weave plays a subordinate role for the strength of the finished product. The only important thing is that a gapless, waterproof surface is obtained with the desired number of fabric layers, which are hot pressed together.

In order to produce a structural element such as, in particular, half-shells of a suitcase, one or more layers of fabric blanks are placed in a heated press mold and pressed under pressure and heat. In this process, the hot forming temperature T3 must lie in the interval from 190° C. to 230° C. The processing temperature T2 of the matrix material lies within this interval.

In order to form a multilayer composite material from several fabric blanks, the hot forming temperature T3 should correspond to the processing temperature T2 of the matrix material or even be a few degrees higher, for example 5° C. to 10°, so that the matrix material melts on the surface and fabric layers pressed against each other bond firmly together.

Provided that a semi-finished product of the composite material is to be pressed into a three-dimensional structure, the hot forming temperature T3 should be approximately the same as the processing temperature T2 of the matrix material, but preferably somewhat lower, preferably about 5° C. to 10° C. lower. This is sufficient for permanent shaping of the composite material, and it prevents the matrix from melting too far and exposing fibers.

Regardless of whether the hot forming temperature is chosen somewhat higher or lower with respect to the processing temperature T2 of the matrix material, the advantage of the invention is that there is still a large temperature difference with respect to the melting temperature T1 of the fiber material. Thus, the fibers are not affected in their properties during hot forming anyway, since their melting temperature is the highest temperature in the overall manufacturing process of the case element, which is not nearly reached. During hot forming, therefore, the temperature window does not have to be maintained to the exact degree in order to reliably avoid any impairment of the mechanical properties.

The structural element formed in this way can also first be a plate-shaped semi-finished product made of the composite material. The welding and pressing of the fabric layers are then carried out by the semi-finished product manufacturer. The processor can produce three-dimensional structural elements from the flat semi-finished product by heating it again to the hot forming temperature or slightly above and then immediately placing it in a press mold and forming it. The surface temperature of the mold cavity of the press mold is preferably below T2, so that no surface melting is caused. In any case, the surface temperature is significantly, namely at least 30° C., preferably 50° C., below T1, in order to avoid any effect on the fibers embedded in the tapes or ribbons. The advantage for the processor is that the energy required for heating a semi-finished product, for example in an oven, is significantly lower than heating the entire pressing tool for a longer period of time.

In particular, the press mold is even kept in the range between room temperature and about 60° C. by cooling. This allows safe handling without special heat protection measures.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a cross-section of a plastic belt;

FIG. 2 shows a top view of a woven fabric of plastic straps; and

FIG. 3 shows an opened case in perspective view

### DETAILED DESCRIPTION

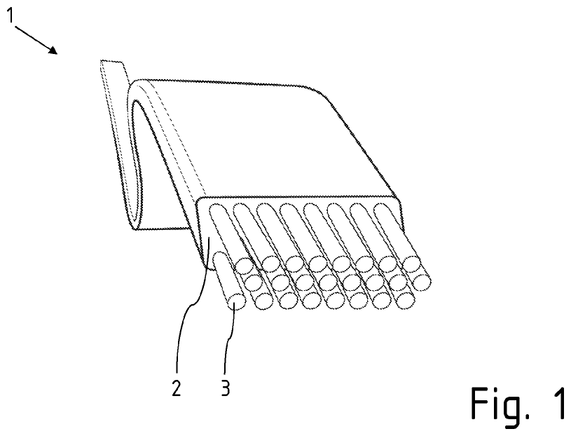

FIG. 1 shows a plastic tape 1 manufactured in accordance with the invention. It includes pre-stretched fibers 2 formed from a partially crystalline polyester homopolymer. They are embedded in a matrix 3 which is also formed by a polyester homopolymer, but in amorphous form, that is to say with a very low degree of crystallization of less than 10% crystalline content. On the other hand, the fibers 2 are made of a partially crystalline polyester, the degree of crystallization being between 30% and 40% for the material of the fibers.

It is essential that there is a sufficiently large gradient between the polyester materials used with regard to the degree of crystallization. Of the maximum degree of crystallization achievable with polyester, which is 30% to 40% in absolute terms, i.e., based on the total volume, the PET polymer from which the matrix is formed has a relative proportion of no more than 10%. The PET fiber material, on the other hand, has a relative degree of crystallization of 75% to 100%—again based on the absolute maximum achievable with the PET type used. This relative distribution of the different degrees of crystallization and the relative difference of more than 60 percentage points between the two materials used result in the large temperature difference in the melting or processing temperatures, which leads to an uncomplicated and cost-effective manufacturing possibility of structural elements from the composite material according to the invention.

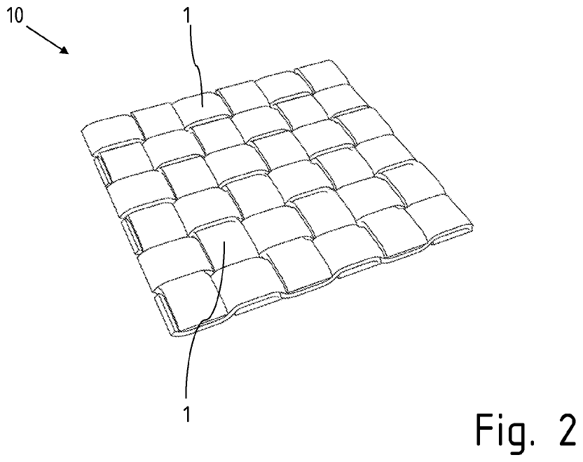

The individual plastic bands 1 are then woven together to form a base fabric. A section of a base fabric 10, in which the plastic tapes 1 are woven together, for example in a simple plain weave, is shown in FIG. 2. The relatively large width of the plastic tapes used is advantageous in order to impart a certain rigidity to the base fabric 10. In the case of complicated three-dimensional shapes with tight radii, a finer weave can be advantageous. The advantage of using large widths of the tapes, in particular up to 25 mm, has the further advantage that a water- and gas-tight structural element can be produced with only a few superimposed and interconnected layers, because the gaps in the fabric are small anyway and the interconnection of several fabric layers completely closes them under pressure and temperature.

A further criterion for the number of layers of the base fabric which are pressed together results from the desired strength of the structural element or the mechanical requirements prevailing thereon in later use. It has been shown that 3 to 6 layers of a fabric are sufficient, the plastic bands in the fabric each having a thickness of 80 μm to 200 μm.

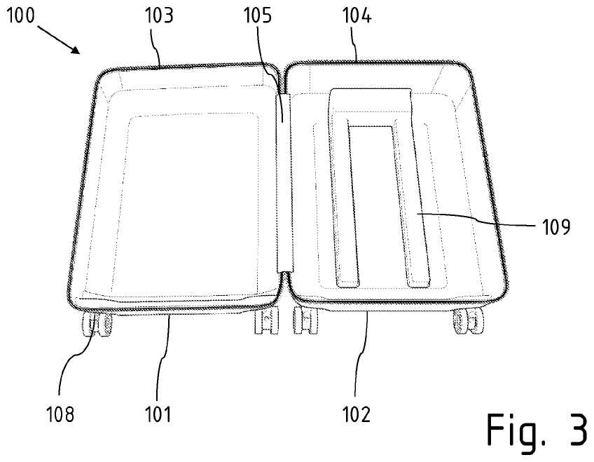

FIG. 3 shows the use of structural elements which are formed from the composite material of the invention, using the example of a suitcase 100. The suitcase 100 has two suitcase shells 101, 102, which are each three-dimensional structural elements which have been formed from the composite material of the invention. The suitcase shells 101, 102 are connected to each other by a textile web 105, which is preferably also made of polyester, in particular of a textile blank made of polyester yarn. The zippers 103, 104, each of which is attached at the edges to the suitcase shells 101, 102, are also preferably made of polyester. Thus, the major part of the suitcase is already recyclable by type. Polyester materials are also used as far as possible for the other attachments, such as castors 108 or an extendable handle 109, so that a modern and durable suitcase 100 is present which is, however, completely recyclable after the end of use.

The consistent selection of PET as a material also ensures the possibility of hot welding. The zippers 103,104 can preferably be inserted directly during hot forming of the fabric blanks and are then pressed into the composite at the edges. However, they can also be welded on subsequently. The same applies to the central web 105 and, if necessary, to other elements that can be welded to the case shells 101, 102, which are the structural components of the case 100.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method of producing a self-reinforced thermoplastic composite material, comprising:
providing strips having a rectangular cross-section and made of a thermoplastic material; and
weaving the strips into a base fabric,
wherein strips are produced by:
producing pre-stretched continuous fibers from a partially crystalline polyester homopolymer having a melting temperature T₁ by extrusion with at least one spinneret and subsequent drawing;
forming a plurality of multifilaments each bundling a plurality of pre-stretched fibers;
spreading the multifilaments to obtain a layer of fibers adapted to the thin rectangular profile of the cross-section of the plastic strip, the width of which is greater than the height; and
bonding a plurality of juxtaposed and/or superimposed pre-stretched continuous fibers, which are in the form of the spread multifilaments and are under prestress, to a matrix of an amorphous polyester homopolymer at a processing temperature T₂<T₁, the temperature difference between T₁ and T₂ being at least ΔT=30° C.

2. The method according to claim 1, wherein the fiber and matrix materials are selected such that the temperature difference between T₁ and T₂ is at least ΔT=50° C.

3. The method according to claim 1, wherein the melting temperature T₁ of the PET fiber material is between 250° C. and 270° C.

4. The method according to claim 1, wherein the relative degree of crystallization of the PET fiber material is more than 75%, based on the maximum absolute degree of crystallization achievable in the PET polymer.

5. The method according to claim 1, wherein the processing temperature T₂ of the PET matrix material when applied to the fibers is between 160° C. and 230° C.

6. The method according to claim 1, wherein the relative degree of crystallization of the PET matrix material, based on the maximum absolute degree of crystallization achievable in the PET polymer, is less than 10%.

7. A method of making a structural member from a composite material made according to claim 1, the method comprising:
cutting the base fabric into at least one fabric blank;
Inserting a fabric blank or several fabric blanks lying on top of each other into a press mold;
heating the at least one fabric blank to a hot working temperature T₃ while substantially simultaneously applying pressure to form the structural member, the hot working temperature T₃ being less than or equal to T₂ and is at least 30° C. below T₁; and
cooling the structural element and removing the structural element from the mold.

8. The method according to claim 7, wherein during the hot forming and structuring of the fabric blank, a textile fabric blank made of polyester fabric is substantially simultaneously welded on at the edge.

9. The method according to claim 7, wherein a planar structural element is first formed as a semi-finished product, which is heated again to the hot forming temperature T₃ and is formed into a three-dimensional structural element in a press mold having a three-dimensionally shaped mold cavity, the surface temperature in the mold cavity at the beginning of the forming of the preheated planar structural element being lower than T₁.

10. A suitcase comprising at least one structural element made according to claim 7.

11. The suitcase according to claim 10, wherein at least one structural element is bonded to at least one textile element made of polyester.

12. The suitcase according to claim 10, wherein two structural elements are provided as suitcase shells that are connected to one another by at least one zipper formed of polyester and/or a textile bridging element.
